(19) United States
(12) Patent Application Publication
(10) Pub. No.: US 2004/0014364 A1
(43) Pub. Date: Jan. 22, 2004

(54) Lamp socket having a double-deck center contact strip

(75) Inventor: Wen Ho Yang, Taipei Hsien (TW)

Correspondence Address: BACON & THOMAS, PLLC, 625 SLATERS LANE, FOURTH FLOOR, ALEXANDRIA, VA, 22314

(73) Assignee: Sun Lite Sockets Industry Inc., Taoyuan Hsien (TW)

(21) Appl. No.: 10/196,961

(22) Filed: Jul. 18, 2002

(51) Int. Cl. H01R 24/00

(52) U.S. Cl. 439/667

(57) ABSTRACT

A lamp socket having a double-deck center contact strip includes a socket body having an inner hollow provided with a metal threaded sleeve for receiving a lamp. The socket body is provided inside with a curve-shaped center contact strip having one side fixed on the socket body, and the other side turning upward and located in the center of the threaded sleeve but separating from the threaded sleeve. The double-deck center contact strip is composed of a copper and a steel contact strip, the copper contact strip located on top for contacting with the contact under a lamp and conducting elasticity, while the steel contact strip positioned under the copper contact strip for reinforcing the elasticity of the center contact strip, thus maintaining good contact between the lamp socket and the lamp for conducting electricity well, prolonging service life and ensuring safety.

### BACKGROUND OF THE INVENTION

This invention relates to a lamp socket having a double-deck center contact strip, particularly to one able to maintain good contact and conductivity between its center contact strip and a lamp, prolonging service life and increasing security.

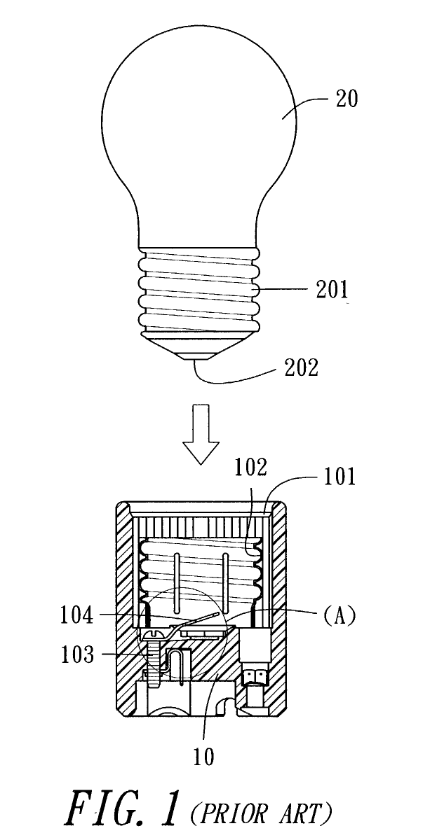

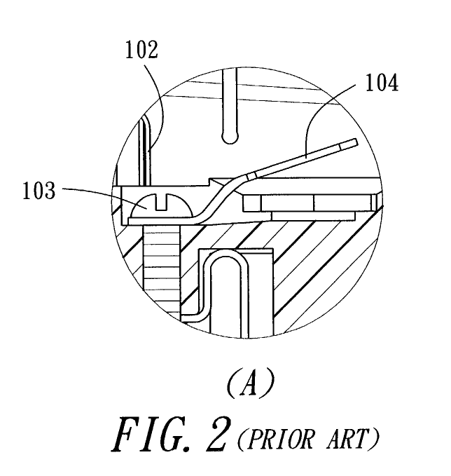

A conventional lamp socket, as shown in FIGS. 1 and 2, includes a socket body 10 having an inner hollow 101 in the upper side. The inner hollow 101 is fitted inside with a metal threaded sleeve 102 conducting with the pole provided in the socket body 10. A center contact strip 104 is threadably fixed on the stage of an inner side of the socket body 10 facing a lamp by a bolt 13 for conducting with the other pole. The center contact strip 104 is commonly made of copper or copper alloy and is curve-shaped. The center contact strip 104 has one end fixed flatly on the socket body 10 by the bolt 103 and the other end turning upward and located in the center of the threaded sleeve 102, separating from the threaded sleeve 102 and leaving a gap therebetween.

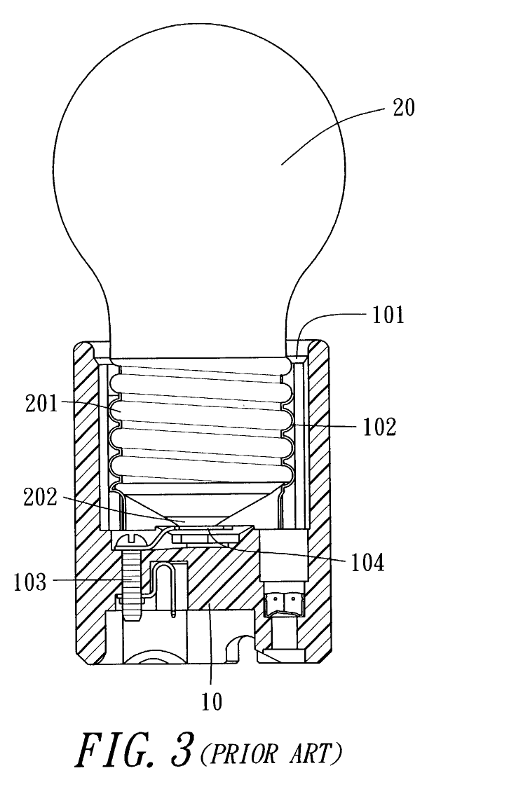

Thus, when a lamp 20 is threadably fitted in the threaded sleeve 20, as shown in FIG. 3, the helical metal head 201 of the lamp 20 is threadably connected closely with the threaded sleeve 102 and conducts with the pole provided in the socket body 10, and the contact 202 under the center bottom of the lamp 20 (not conducting with the metal head 201) presses on the center contact strip 104 of the socket body 10 and conducts with the other pole, letting the socket body 10 and the lamp 20 make up a circuit so as to make electric connection for lighting when powered.

The center contact strip 104 of a conventional lamp socket is made of copper or copper alloy which has good conductivity, nevertheless, after replacing the lamp repeatedly or lighting the lamp for a long period of time, such a center contact strip 104 may by degrees become inelastic due to constant pressing of the contact 202 of the lamp 20, as shown in FIG. 3, and the thermal effect produced by electric current. Under this condition, the center contact strips 104 no longer has function to closely contact with the contact 202 of the lamp 20 and as a result, a comparatively large resistance produces between the contact 202 of the lamp 20 and the center contact strip 104 of the socket body 10 and then the temperature between them becomes higher and higher and causes a short circuit to burn up the lamp socket and even worse, give rise to a fire.

In view of this, a spring is provided under the center contact strip 104 in order to hold up the center contact strip 104 to increase its resilience for solving the problem described above, thus increasing producing cost and causing much difficulty in assembling.

### SUMMARY OF THE INVENTION

The objective of the invention is to offer a lamp socket having a double-deck center contact strip able to maintain good contact and conductivity between a lamp socket and a lamp, increase service life and ensure safety.

The feature of the invention is that the lamp socket includes a socket body having an inner hollow in the upper portion, and the inner hollow is provided inside with a metal threaded sleeve for receiving a lamp and conducting with the pole provided in the socket body. A center contact strip is fixed on the stage in an inner side of the socket body facing the lamp. The center contact strip conducts with the other pole and is curve-shaped, having one end fixed on the socket body and the other end turning upward and located in a center of the threaded sleeve, separating from the threaded sleeve. The double-deck center contact strip is composed of a copper and a steel contact strip combined together, the copper contact strip positioned on top for contacting with the contact under the center bottom of the lamp for conducting electricity, while the steel contact strip positioned under the copper contact strip for reinforcing elasticity of the whole center contact strip. Thus, the lamp socket in the invention is capable of maintaining good contact between a lamp socket and a lamp, prolonging its service life and ensuring safety in use.

### BRIEF DESCRIPTION OF THE INVENTION

This invention will be better understood by referring to the accompanying drawings, wherein:

FIG. 1 is a cross-sectional view of a conventional lamp socket:

FIG. 2 is a magnified view of (A) in FIG. 1:

FIG. 3 is a cross-sectional of the conventional lamp socket:

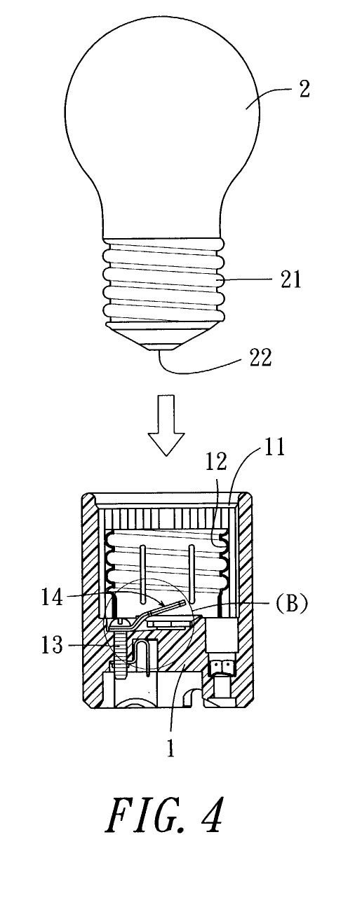

FIG. 4 is a cross-sectional view of a lamp socket in the present invention:

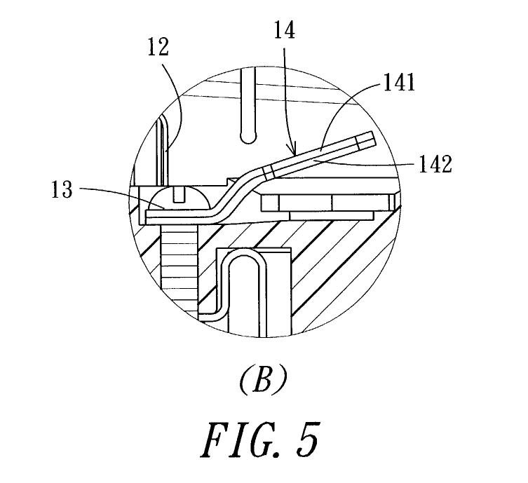

FIG. 5 is a magnified view of (B) in FIG. 4: and

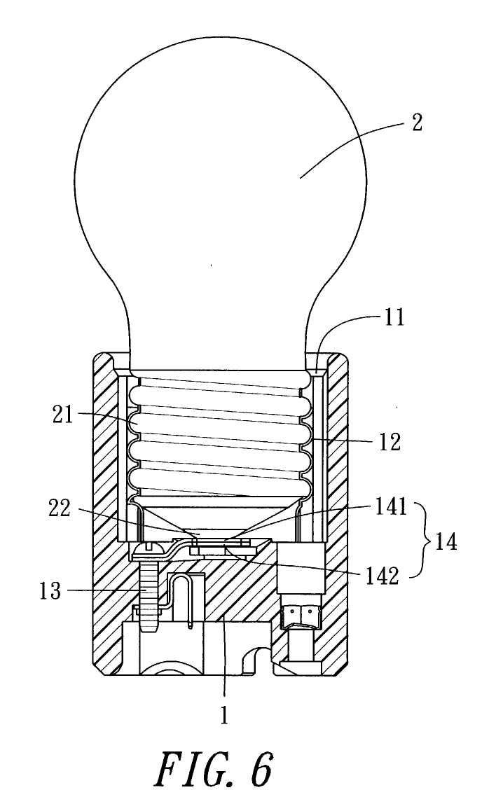

FIG. 6 is a cross-sectional view of the lamp socket in the present invention.

### DETAILED DESCRIPTION OF THE PREFERRED EMBODIMENT

A preferred embodiment of a lamp socket having a double-deck center contact strip in the present invention, as shown in FIGS. 4 and 5, includes a socket body 1 having an inner hollow 111 in the upper side. The inner hollow 11 is fitted inside with a metal threaded sleeve 12 conducting with the pole provided in the socket body 1. A double-deck center contact strip 14 is fixed on the stage in an inner side of the socket body 1 facing a lamp 2 by means of a bolt 13 for conducting with the other pole.

The double-deck center contact strip 14 is composed of a copper contact strip 141 and a steel contact strip 142 combined together, the copper contact strip 141 located on the steel contact strip 142 for contacting with the contact under the center bottom of the lamp 2 and conducting electricity, while the steel contact strip 142 positioned under the copper contact strip 141 for reinforcing the elasticity of the whole center contact strip 14. The center contact strip 14 has one end threadably secured flatly on the socket body 1 by a bolt 13, and the other end turning upward and located in the center of the metal threaded sleeve 12, separating from the threaded sleeve 12.

By so designing, when the lamp 2 is threadably combined with the threaded sleeve 2, as shown in FIG. 6, the helical metal head 21 of the lamp 2 is closely connected with the metal thread sleeve 12 and conducts with the pole provided in the socket body 1, and the contact 22 under the center bottom of the lamp 2 (not conducting with the helical metal head 21) presses on the center contact strip 14 and conducts with the other pole, thus forming a circuit between the socket body 1 and the lamp 2 and making electric connection for lighting after supplying power.

To sum up, the double-deck center contact strip 14 in this invention is composed of an upper copper contact strip 141 and a lower steel contact strip 142. The upper copper contact strip 141 contacts with and props up the contact 22 of the lamp 2 for conducting electricity, while the lower steel contact strip 142 with good elasticity can hold up the copper contact strip 141 to always turn upward and closely contact with the contact 22 of the lamp 2.

Thus, the center contact strip 14 and the contact 22 of the lamp 2 can always maintain a condition of closely contacting each other, therefore neither large resistance nor excessively high temperature may produce and the center contact strip 14 can always maintain good elasticity even though the lamp 2 is replaced for many times or the lamp is lit for a long period of time, thus increasing its service life and ensuring safety in use.

While the preferred embodiment of the invention has been described above, it will be recognized and understood that various modifications may be made therein and the appended claims are intended to cover all such modifications that may fall within the spirit and scope of the invention.

I claim

1. A lamp socket having a double-deck center contact strip comprising a socket body having an inner hollow in the upper side, said inner hollow provided inside with a metal threaded sleeve for threadably receiving a lamp, said metal threaded sleeve conducting with the pole provided in said socket body, a double-deck center contact strip fixed on the stage in an inner side of said socket body facing a lamp, said double-deck center contact strip conducting with the other pole, said double-deck enter contact strip curve-shaped and having one end fixed on said socket body and the other end turning upward and located in the center of said threaded sleeve, said turning-up end of said center contact strip separating from said threaded sleeve, said double-deck center contact strip composed of a copper and a steel contact strip combined together, said copper contact strip positioned on said steel contact strip, said copper contact strip contacting with the contact under the center bottom of said lamp for conducting electricity, said steel contact strip positioned under said copper contact strip, said steel contact strip reinforcing the elasticity of said center contact strip, said double-deck center contact strip enabling said lamp socket and said lamp to maintain good contact there between for conducting electricity.
